(19) United States
(12) Patent Application Publication
(10) Pub. No.: US 2011/0122358 A1
(43) Pub. Date: May 26, 2011

(54) LIQUID CRYSTAL DISPLAY AND METHOD FOR MANUFACTURING THE SAME

(76) Inventors: Jang-Kyum KIM, Seoul (KR); Hee-Keun Lee, Suwon-si (KR); Nak-Cho Choi, Seoul (KR)

(21) Appl. No.: 12/906,962

(22) Filed: Oct. 18, 2010

(30) Foreign Application Priority Data
Nov. 25, 2009 (KR) 10-2009-0114628

(51) Int. Cl. G02F 1/1339; B05D 5/12; C08J 7/18; B29C 59/02

(52) U.S. Cl. 349/156; 427/58; 427/510; 264/293

(57) ABSTRACT

A method of manufacturing a liquid crystal display including a cholesteric liquid crystal and having a first insulation substrate and a second insulation substrate that face each other, the method comprising: forming an organic layer on the first insulation substrate or the second insulation substrate; pressing a mold onto the organic layer; hardening the organic layer; and removing the mold so as to form a cell gap formation pattern in the organic layer, the cell gap formation pattern including first, second, and third portions each having different thicknesses.

### CROSS-REFERENCE TO RELATED APPLICATION

This application claims priority to, and the benefit of, Korean Patent Application No. 10-2009-000114628 filed in the Korean Intellectual Property Office on Nov. 25, 2009, the entire contents of which are incorporated herein by reference.

### BACKGROUND OF THE INVENTION

(a) Field of the Invention

The present invention relates to liquid crystal displays. More particularly, the present invention relates to liquid crystal displays including cholesteric liquid crystals.

(b) Background

In general, a cholesteric liquid crystal display is a reflective liquid crystal display with attributes including relatively low power consumption and high screen luminance. In cholesteric liquid crystal displays, cholesteric liquid crystals are mixed with chiral dopants, resulting in a helical structure that selectively reflects light having the same wavelength as a helical pitch of the liquid crystal, so as to control light transmittance for each pixel.

Here, the reflected light has a wavelength corresponding to the product of the pitch of the liquid crystal and the refractive anisotropy (Δn). The pitch of the liquid crystal may be controlled by the amount of chiral dopant added. When a large amount of chiral dopant is added, the resultant short pitch reflects light having a shorter wavelength, and when a smaller amount of chiral dopant is added, the resultant long pitch reflects light of a longer wavelength.

This cholesteric liquid crystal display can have different driving voltages for each pixel or sub-pixel color (e.g., red, green, and blue). Thus, for example, if the driving voltage of the blue sub-pixels is also used to drive the red and the green sub-pixels, the red and green sub-pixels are not driven to the proper luminance.

The above information disclosed in this Background section is only for enhancement of understanding of the background of the invention, and therefore it may contain information not in the prior art.

### SUMMARY OF THE INVENTION

Accordingly, the present invention simplifies the process to form the different cell gaps for each pixel.

One embodiment concerns a method of manufacturing a liquid crystal display including a cholesteric liquid crystal and having a first insulation substrate and a second insulation substrate that face each other. The method includes: forming an organic layer on the first insulation substrate or the second insulation substrate; pressing a mold onto the organic layer; hardening the organic layer; and removing the mold so as to form a cell gap formation pattern in the organic layer, the cell gap formation pattern including first, second, and third portions each having different thicknesses.

The first insulation substrate may include a gate line, a data line intersecting the gate line, a thin film transistor connected to the gate line and the data line, and a pixel electrode connected to the thin film transistor.

The organic layer may include a black color pigment.

The second insulation substrate may include an overcoat and a common electrode formed on the overcoat, and the organic layer may be the overcoat.

The organic layer may include a material that is hardened by at least one of heat and ultraviolet radiation.

A liquid crystal display according to the present invention includes: a first substrate; a cell gap formation pattern formed on the first substrate; a pixel electrode formed on the cell gap formation pattern; a second substrate facing the first substrate; a common electrode formed on the second substrate; a cholesteric liquid crystal layer positioned between the common electrode and the pixel electrode; and a partition dividing the cholesteric liquid crystal layer into regions, wherein the cell gap formation pattern has first, second, and third portions each having different thicknesses.

The cell gap formation pattern may include an organic material, and the organic material may be hardened by heat or UV.

The cell gap formation pattern may be an organic material including a black color pigment, and the organic material may be hardened by at least one of heat and ultraviolet radiation.

The partition may include a same material as the cell gap formation pattern.

The thickness of the first portion may be greater than the thickness of the second portion, and the thickness of the second portion may be greater than the thickness of the third portion.

The first portion may correspond to a red region, the second portion may correspond to a green region, and the third portion may correspond to a blue region.

The liquid crystal display may further include: a gate line formed on the first substrate; a data line intersecting the gate line; and a thin film transistor connected to the gate line and the data line, wherein the pixel electrode is connected to the thin film transistor, and the cell gap formation pattern is formed on the thin film transistor.

The cell gap formation pattern may include a black color pigment.

An overcoat formed on the cell gap formation pattern may be further included.

Accordingly, the different cell gaps per each color may be easily formed through the pressing process (or an embossing stamp) using the mold according to the present invention.

### BRIEF DESCRIPTION OF THE DRAWINGS

FIG. 1 is a cross-sectional view of a liquid crystal display according to an exemplary embodiment of the present invention.

FIG. 2 and FIG. 3 are cross-sectional views sequentially showing a method for forming a pattern for a cell gap having varying thicknesses according to the present invention.

FIG. 4 is a cross-sectional view of a liquid crystal display according to an exemplary embodiment of the present invention.

FIG. 5 is a cross-sectional view of a liquid crystal display according to another exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

As above, a cholesteric liquid crystal display typically requires different driving voltages for each color. One way to drive different color pixels or sub-pixels with the same driving voltage is to form different cell gaps for each color. However, separate etching processes are typically required to form the different cell gaps for each pixel, complicating the fabrication process. Accordingly, embodiments of the invention produce a substrate with a cell gap formation pattern having different thicknesses for each color. The varying heights of this cell gap formation pattern can be fabricated without separate etching steps, yielding a display whose cell gap varies with color, but is still simple to fabricate. In this manner, embodiments of the invention allow for a cholesteric liquid crystal display whose different colors can all be driven with the same voltage, but that remains relatively easy to fabricate.

An exemplary embodiment of the present invention will hereinafter be described in detail with reference to the accompanying drawings.

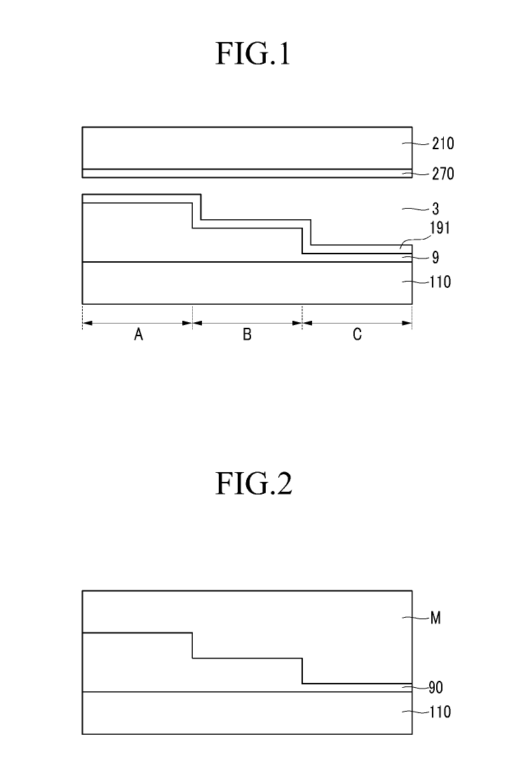

FIG. 1 is a cross-sectional view of a liquid crystal display according to an exemplary embodiment of the present invention.

Referring to FIG. 1, liquid crystal display includes a lower panel with a pixel electrode 191 formed on a substrate 110, an upper panel including a common electrode 270 formed on a substrate 210, and a liquid crystal layer 3 between the two display panels. The liquid crystal layer 3 is made of a cholesteric liquid crystal and includes a chiral dopant.

The liquid crystal display of this embodiment has different cell gaps for each pixel color. In particular, the lower panel includes a cell gap formation pattern 9, and the pattern 9 includes first to third portions A-C each having different thicknesses.

Any suitable thicknesses are contemplated. However, in the embodiment shown, the thicknesses of the first to third portions A-C have a relationship of A>B>C, and accordingly the cell gap has a relationship of A<B<C. Here, the pitch of the liquid crystal is controlled in the first portion A for display of blue, in the second portion B for green, and in the third portion C for red.

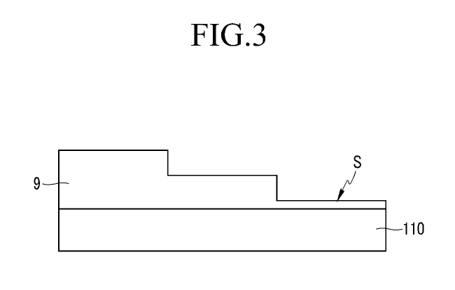

Next, a method for differentiating the cell gap of the liquid crystal display will be described with reference to FIGS. 2-3. FIG. 2 and FIG. 3 are cross-sectional views sequentially showing a method for forming a pattern for a cell gap having the different thicknesses according to the present invention.

First, as shown in FIG. 2, a cell gap formation material layer 90 is coated on a substrate 110. The cell gap formation material layer 90 may be made of any suitable material, such as an organic material to be hardened by heat or UV.

Next, a mold M is disposed on the cell gap formation material layer 90, and pressure is applied to shape the layer 90 according to the mold. The mold M has heights opposite to the height of the pattern, so that the mold M presses the layer 90 to the correct heights.

Here, as shown in FIG. 3, the cell gap formation material layer 90 is hardened by UV or heat. Next, the mold is removed to form a cell gap formation pattern 9.

The cell gap formation pattern 9 is used to form the different cell gaps in the first to third portions A to C. Depending on the application, the cell gap formation material may be removed entirely from the third portion C. To accomplish this, the remaining layer S of the third portion may be removed through ashing. In other applications, the remaining layer S may be kept, i.e. not removed.

The above-described process yields a cell gap formation pattern with different thicknesses, that may be relatively easily formed without using a separate etching process.

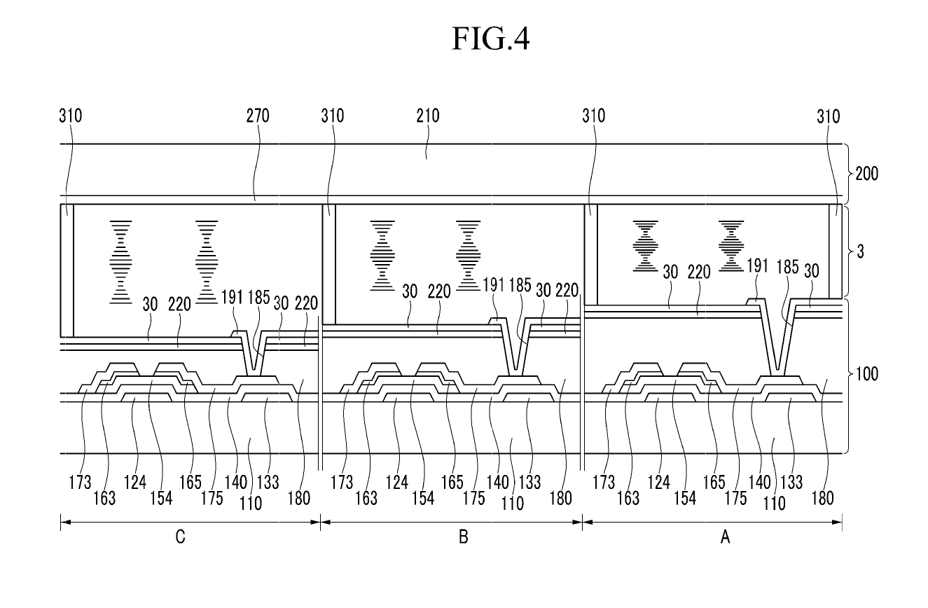

FIG. 4 illustrates a liquid crystal display incorporating the cell gap formation pattern 9 of FIG. 1. More specifically, FIG. 4 is a cross-sectional view of a liquid crystal display according to an exemplary embodiment of the present invention. The liquid crystal display of FIG. 4 includes a lower panel 100 and upper panel 200, with a liquid crystal layer 3 placed therebetween.

Referring to the lower panel 100, a gate line and a storage electrode line are formed on an insulation substrate 110 made of transparent glass or plastic. The gate line transmits a gate signal, and extends in a substantially transverse direction. The gate line includes a gate electrode 124 which protrudes from the gate line.

The storage electrode line receives a predetermined voltage and extends substantially in the transverse direction. Each storage electrode line includes a storage electrode 133 that extends from the storage electrode line.

A gate insulating layer 140 is formed on the gate electrode 124 and the storage electrode 133. The gate insulating layer 140 may be made of any suitable insulating material, such as silicon oxide or silicon nitride.

A semiconductor 154 made of hydrogenated amorphous silicon or crystallized silicon is formed on the gate insulating layer 140. A pair of ohmic contacts 163 and 165 are then formed on the semiconductor 154, and face each other.

A data line, including a source electrode 173 and a drain electrode 175, is formed on the ohmic contacts 163 and 165 and the gate insulating layer 140.

The data line transmits a data signal and extends substantially in the longitudinal direction, thereby intersecting the gate line.

The drain electrode 175 faces the source electrode 173 with respect to the gate electrode 124.

A gate electrode 124, a source electrode 173, and a drain electrode 175 form a thin film transistor (TFT) along with the semiconductor 154. The channel of the thin film transistor is formed in the semiconductor 154 between the source electrode 173 and the drain electrode 175.

A passivation layer 180 is formed on the drain electrode 175, the source electrode 173, and the exposed semiconductor 154. The passivation layer 180 may be made of any suitable material, such as an inorganic insulator such as silicon nitride, silicon oxide, or an organic insulator and an insulating material having a dielectric ratio of less than 4.0.

The passivation layer 180 (made of organic material) may be used as the cell gap formation pattern, and may be pressed so as to have first through third portions A-C with different thicknesses. The passivation layer 180 formed into different thicknesses through the method shown in FIG. 2 and FIG. 3.

An absorption layer 220 is formed on the passivation layer 180. The absorption layer 220 may be made of an organic material including pigments such as black color pigments.

Among the ambient light incident to the liquid crystal layer, the light of wavelength corresponding to the liquid crystal pitch is reflected, and the remaining unreflected light is absorbed by the absorption layer 220. For black, the liquid crystal pitch is controlled so that all light is transmitted, i.e. none is reflected. All light is thus absorbed by the absorption layer 220, so that black is displayed.

An overcoat 30 is formed on the absorption layer 220. The overcoat 30 prevents impurities outgassed from the absorption layer 220 from flowing into the liquid crystal, and may reduce the influence of the dielectric ratio due to the absorption layer 220.

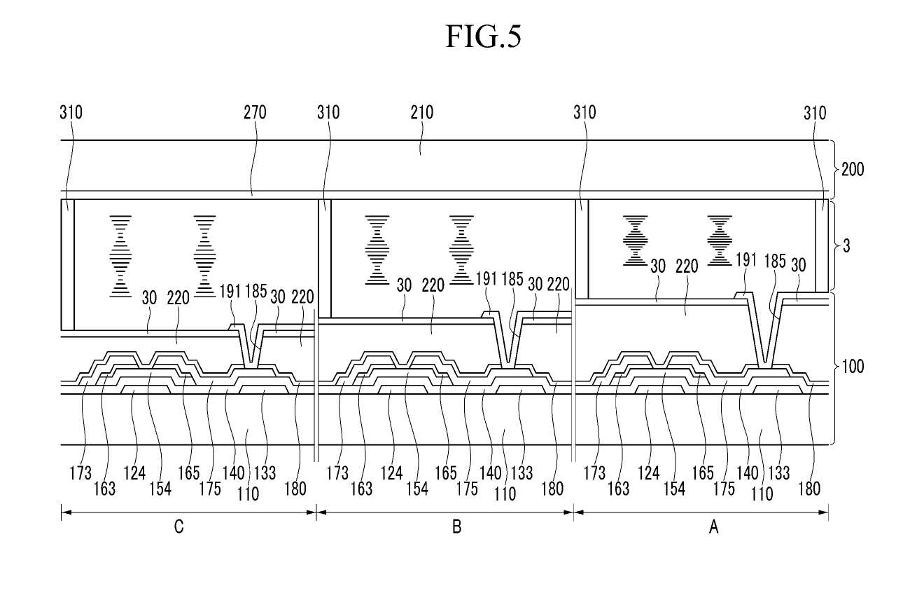

In the example of FIG. 4, passivation layer 180 is used as the cell gap formation pattern. However, the invention contemplates use of any layer as the cell gap formation pattern. In particular, the invention contemplates use of any suitable pattern that can be imprinted with different heights, creating varying cell gaps. In the example of FIG. 5, the absorption layer 220 may be used as the cell gap formation pattern and the overcoat 30 may be formed thereover. Although not shown in the figures, further embodiments may also include use of the overcoat 30 as the cell gap formation pattern.

In FIG. 5, the overcoat 30 and the absorption layer 220 have a contact hole 185 exposing the drain electrode 175.

A pixel electrode 191 and a partition 310 are formed on the overcoat 30. The pixel electrode 191 is made of a transparent conductive material such as ITO and IZO, and is electrically connected to the drain electrode 175 through the contact hole 185.

The partition 310 may be made of an organic insulating material, and may be made of the same material as the absorption layer 220. Also, one of ordinary skill in the art will observe that the partition 310 can be formed using the mold M shown in FIG. 2 and FIG. 3, thereby simplifying the process.

The liquid crystal of the liquid crystal display of the present invention represents a special color according to its pitch, so that neighboring colors can require differently-pitched liquid crystal. Accordingly, the partition 310 prevents the mixture of the neighboring colors. The shape of the partition 310 may be changed according to the arrangement of the colors. For example, the partition 310 may be extended along the pixel row or the pixel column, or may be formed with a shape enclosing each pixel.

When forming the partition 310 to be extended, the liquid crystal may be injected through vacuum injection. Alternatively, when forming a shape enclosing the pixel, the liquid crystal layer may be formed through an Inkjet method or a dripping method. The partition 310 may also be used as a spacer to maintain the interval of the upper substrate.

An alignment layer (not shown) may be formed on the pixel electrode 191.

Next, upper panel 200 is described. The upper panel 200 includes a substrate 210, and a common electrode 270 formed on the substrate 210. An alignment layer (not shown) may also be formed on the common electrode 270.

As above, the invention includes embodiments in which the passivation layer is used as the cell gap formation pattern. However, the invention also includes embodiments in which any other suitable layer, such as an overcoat layer, is instead used as the cell gap formation pattern. Additionally, the invention contemplates formation of the partition 310 in either the lower panel 100 or the upper panel 200.

A cholesteric liquid crystal layer is formed between the two display panels 100 and 200, and has a helical structure. Also, the first portion A is used in the blue pixel (or sub-pixel), the second portion B is used in the green pixel (or sub-pixel), and the third portion C is used in the red pixel (or sub-pixel).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing a liquid crystal display including a cholesteric liquid crystal and having a first insulation substrate and a second insulation substrate that face each other, the method comprising:
forming an organic layer on the first insulation substrate or the second insulation substrate;
pressing a mold onto the organic layer;
hardening the organic layer; and
removing the mold so as to form a cell gap formation pattern in the organic layer, the cell gap formation pattern including first, second, and third portions each having different thicknesses.

2. The method of claim 1, wherein
the first insulation substrate includes a gate line, a data line intersecting the gate line, a thin film transistor connected to the gate line and the data line, and a pixel electrode connected to the thin film transistor, and
the organic layer is formed on the thin film transistor.

3. The method of claim 2, wherein
the organic layer includes a black color pigment.

4. The method of claim 1, wherein
the second insulation substrate includes an overcoat and a common electrode formed on the overcoat, and
the organic layer is the overcoat.

5. The method of claim 1, wherein
the organic layer includes a material that is hardened by at least one of heat and ultraviolet radiation.

6. A liquid crystal display comprising:
a first substrate;
a cell gap formation pattern formed on the first substrate;
a pixel electrode formed on the cell gap formation pattern;
a second substrate facing the first substrate;
a common electrode formed on the second substrate;
a cholesteric liquid crystal layer positioned between the common electrode and the pixel electrode; and
a partition dividing the cholesteric liquid crystal layer into regions,
wherein the cell gap formation pattern has first, second, and third portions each having different thicknesses.

7. The liquid crystal display of claim 6, wherein
the cell gap formation pattern includes an organic material.

8. The liquid crystal display of claim 7, wherein
the organic material is hardened by at least one of heat and ultraviolet radiation.

9. The liquid crystal display of claim 6, wherein
the cell gap formation pattern includes an organic material, the organic material including a black color pigment.

10. The liquid crystal display of claim 9, wherein
the organic material is hardened by at least one of heat and ultraviolet radiation.

11. The liquid crystal display of claim 9, wherein
the partition includes a same material as the cell gap formation pattern.

12. The liquid crystal display of claim 6, wherein
the thickness of the first portion is greater than the thickness of the second portion, and the thickness of the second portion is greater than the thickness of the third portion.

13. The liquid crystal display of claim 12, wherein
a cell gap of the third portion is greater than a cell gap of the second portion, and the cell gap of the second portion is greater than a cell gap of the first portion.

14. The liquid crystal display of claim 13, wherein
the first portion corresponds to a red region, the second portion corresponds to a green region, and the third portion corresponds to a blue region.

15. The liquid crystal display of claim 6, further comprising:
a gate line formed on the first substrate;
a data line intersecting the gate line; and
a thin film transistor connected to the gate line and the data line,
wherein the pixel electrode is connected to the thin film transistor, and
the cell gap formation pattern is formed on the thin film transistor.

16. The liquid crystal display of claim 15, wherein
the cell gap formation pattern includes a black color pigment.

17. The liquid crystal display of claim 15, further comprising
an overcoat formed on the cell gap formation pattern.
